(19) United States
(12) Patent Application Publication
(10) Pub. No.: US 2013/0009523 A1
(43) Pub. Date: Jan. 10, 2013

(54) ELECTROMECHANICAL DEVICE, ROBOT, AND MOBILE UNIT

(75) Inventor: Kesatoshi TAKEUCHI, Shiojiri (JP)

(73) Assignee: SEIKO EPSON CORPORATION, Tokyo (JP)

(21) Appl. No.: 13/542,248

(22) Filed: Jul. 5, 2012

(30) Foreign Application Priority Data
Jul. 6, 2011 (JP) 2011-149644

(51) Int. Cl. H02K 11/00

(52) U.S. Cl. 310/68 B

(57) ABSTRACT

An electromechanical device includes: a rotor including a center axis, a permanent magnet arranged on a first cylindrical surface along an outer periphery, and first and second magnet side yokes arranged at both end parts, of the permanent magnet; and a stator including an electromagnetic coil arranged on a second cylindrical surface along an outer periphery of the permanent magnet, and a magnetic sensor arranged opposite the permanent magnet with the first magnet side yoke located between the magnetic sensor and the permanent magnet. The first and second magnet side yokes are configured in such a way that a magnetic flux density on a surface opposite to the permanent magnet, of the second magnet side yoke on the side where the magnetic sensor is not arranged, is smaller than a magnetic flux density on a surface opposite to the permanent magnet, of the first magnet side yoke.

### BACKGROUND

1. Technical Field

The present invention relates to an electromechanical device, a robot, and a mobile unit.

2. Related Art

A technique where a magnetic body is arranged on the side of an open magnetic circuit of a rotor magnet of a motor, thereby attracting a magnetic flux that leaks from the rotor magnet to the magnetic body, reducing a magnetic flux that enters other fixed members arranged near the rotor magnet, and thus reducing the occurrence of an eddy current in the other fixed members, is known (for example, JP-A-2006-259446).

Meanwhile, in controlling the motor, in some cases, a magnetic sensor for detecting the phase of the rotor magnet may be arranged near the rotor magnet and the operation of the motor may be controlled using an output from the magnetic sensor. In such cases, if a magnetic flux leaking from the magnetic body is reduced excessively, the phase of the rotor magnet cannot be detected and the motor cannot be controlled. In the related-art technique, a configuration of the magnetic body that takes into consideration both the occurrence of an eddy current and the detection of a magnetic flux by the magnetic sensor is not examined sufficiently.

### SUMMARY

An advantage of some aspects of the invention is that an eddy current loss is restrained and that efficiency of an electromechanical device is improved.

The invention can be implemented as the following forms or application examples.

### APPLICATION EXAMPLE 1

This application example is directed to an electromechanical device including: a rotor including a center axis, a permanent magnet arranged on a first cylindrical surface along an outer periphery of the center axis, and first and second magnet side yokes arranged at both end parts in a direction of the center axis, of the permanent magnet; and a stator including an electromagnetic coil arranged on a second cylindrical surface along an outer periphery of the permanent magnet, and a magnetic sensor arranged opposite the permanent magnet with the first magnet side yoke located between the magnetic sensor and the permanent magnet. The first and second magnet side yokes are configured in such a way that a magnetic flux density on a surface opposite to the permanent magnet, of the second magnet side yoke on the side where the magnetic sensor is not arranged, is smaller than a magnetic flux density on a surface opposite to the permanent magnet, of the first magnet side yoke.

According to this application example, the magnetic flux density on the surface opposite to the permanent magnet, of the second magnet side yoke on the side where the magnetic sensor is not arranged, is smaller than the magnetic flux density on the surface opposite to the permanent magnet, of the first magnet side yoke on the side where the magnetic sensor is arranged. Therefore, while the magnetic flux density at the magnetic sensor is maintained at a sufficient level for the detection thereof, an eddy current loss on the side where the magnetic sensor is not arranged can be restrained and the efficiency of the electromechanical device can be improved.

### APPLICATION EXAMPLE 2

This application example is directed to the electromechanical device according to Application Example 1, wherein the first and second magnet side yokes are configured in such a way that a thickness in a direction along the center axis of the second magnet side yoke is thicker than a thickness in a direction along the center axis of the first magnet side yoke.

According to this application example, the thickness in the direction along the center axis of the second magnet side yoke is configured to be thicker than the thickness in the direction along the center axis of the first magnet side yoke. Therefore, the magnetic flux density on the surface opposite to the permanent magnet, of the second magnet side yoke on the side where the magnetic sensor is not arranged, can be made smaller than the magnetic flux density on the surface opposite to the permanent magnet, of the first magnet side yoke.

### APPLICATION EXAMPLE 3

This application example is directed to the electromechanical device according to Application Example 1 or 2, wherein the second magnet side yoke is made of a material with a higher relative permeability than the first magnet side yoke.

According to this application example, since the second magnet side yoke is made of a material with a higher relative permeability than the first magnet side yoke, the magnetic flux density on the surface opposite to the permanent magnet, of the second magnet side yoke on the side where the magnetic sensor is not arranged, can be made smaller than the magnetic flux density on the surface opposite to the permanent magnet, of the first magnet side yoke.

### APPLICATION EXAMPLE 4

This application example is directed to the electromechanical device according to any of Application Examples 1 to 3,

wherein the magnetic flux density on the surface opposite to the permanent magnet, of the first magnet side yoke, is equal to or greater than 100 millitesla but smaller than or equal to 300 millitesla, and the magnetic flux density on the surface opposite to the permanent magnet, of the second magnet side yoke, is less than 20 millitesla.

According to this application example, a high detection accuracy of the magnetic flux density by the magnetic sensor can be maintained and an eddy current loss can be restrained on the side of the second magnet side yoke, thus improving the efficiency of the electromechanical device.

### APPLICATION EXAMPLE 5

This application example is directed to a robot including the electromechanical device according to any of Application Examples 1 to 4.

### APPLICATION EXAMPLE 6

This application example is directed to a mobile unit including the electromechanical device according to any of Application Examples 1 to 4.

The invention can be realized in various forms. For example, the invention can be implemented as the form of an electromechanical device such as a motor or power generating device, or in the form of a robot, mobile unit or the like using the electromechanical device.

### BRIEF DESCRIPTION OF THE DRAWINGS

The invention will be described with reference to the accompanying drawings, wherein like numbers reference like elements.

FIGS. 1A and 1B are explanatory views showing the configuration of a coreless motor.

FIG. 2 is an explanatory view showing a coil back yoke and electromagnetic coils expanded along a cylindrical surface, as viewed from the side of the coil back yoke.

FIGS. 3A to 3C are explanatory views showing a vicinity of a magnet side yoke on the side of a magnetic sensor, in an enlarged manner.

FIG. 4 is an explanatory view showing an example of output signal from a magnetic sensor.

FIGS. 5A to 5C are explanatory views showing a vicinity of a magnet side yoke opposite to the magnetic sensor, in an enlarged manner.

FIG. 6A is an explanatory view showing an example of an iron loss measuring method.

FIG. 6B is an explanatory view showing the relation between the thickness of the magnet side yoke and the iron loss of a motor to be measured.

FIG. 7 is an explanatory view showing the relation between the thickness of the magnet side yoke and the magnetic flux density on the surface of the magnet side yoke.

FIG. 8 is an explanatory view showing an electric-powered bicycle (power-assisted bicycle) as an example of a mobile unit utilizing a motor/power generator according to a modification of an embodiment of the invention.

FIG. 9 is an explanatory view showing an example of a robot utilizing a motor according to a modification of an embodiment of the invention.

FIG. 10 is an explanatory view showing an example of a two-arm seven-axis robot utilizing a motor according to a modification of an embodiment of the invention.

FIG. 11 is an explanatory view showing a railway vehicle utilizing a motor according to a modification of an embodiment of the invention.

### DESCRIPTION OF EXEMPLARY EMBODIMENTS

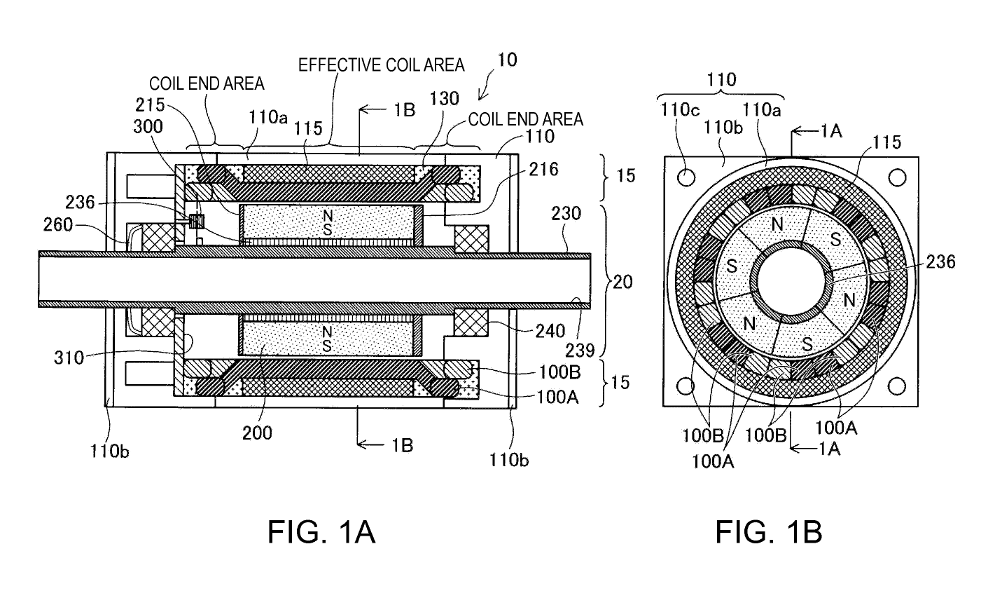

FIGS. 1A and 1B are explanatory views showing the configuration of a coreless motor. FIG. 1A schematically shows a cross section taken along a plane parallel to a center axis 230 of a coreless motor 10 (along a section 1A-1A shown in FIG. 1B). FIG. 1B schematically shows a cross section taken along a plane perpendicular to the center axis 230 of the coreless motor (along a section 1B-1B shown in FIG. 1A).

The coreless motor 10 is an inner rotor-type motor having a substantially cylindrical stator 15 arranged outside and a substantially cylindrical rotor 20 arranged inside. The stator 15 includes electromagnetic coils 100A, 100B, a casing 110, a coil back yoke 115, and a magnetic sensor 300. The rotor 20 includes the center axis 230, a permanent magnet 200, magnet side yokes 215, 216, a magnet back yoke 236, a bearing 240, and a wave spring washer 260.

The rotor 20 has the center axis 230 at the center. The magnet back yoke 236 is arranged on an outer periphery of the center axis 230. Six permanent magnets 200 are arranged on an outer periphery of the magnet back yoke 236. The six permanent magnets 200 include permanent magnets 200 which are magnetized in an outward direction from the center of the center axis 230 (radial direction) and permanent magnets 200 which are magnetized in a direction toward the center of the center axis 230 from outside (central direction). The permanent magnets 200 whose direction of magnetization is the central direction and the permanent magnets 200 whose direction of magnetization is the radial direction are arranged alternately along a circumferential direction. The symbols “N” and “S” appended to the permanent magnets 200 in FIG. 1B indicate the polarities of the magnetic poles on the outer side of the permanent magnet 200.

The magnet side yokes 215, 216 are provided at end parts in a direction along the center axis 230 of the permanent magnet 200. The magnet side yokes 215, 216 are disc-like members made of a soft magnetic material. Outside the magnet side yoke 215, the magnetic sensor 300 is provided on the stator 15. The magnet side yoke 215 on the side where the magnetic sensor 300 is arranged is called a “first magnet side yoke 215”, and the magnet side yoke 216 opposite to the side where the magnetic sensor 300 is arranged is called a “second magnet side yoke 216”. A thickness in a direction along the center axis 230 of the magnet side yoke 215 is thinner than a thickness in a direction along the center axis 230 of the magnet side yoke 216. Since a magnetic flux can more easily pass through a soft magnetic material than in air, a magnetic flux leaking in the direction of the center axis 230, of magnetic fluxes from the permanent magnet 200, tends to pass through the magnet side yokes 215, 216.

The center axis 230 is made of a carbon fiber reinforced plastic and has a through-hole 239. The center axis 230 is supported by the bearing 240 of the casing 110 and attached to the casing 110. In this embodiment, the wave spring washer 260 is provided inside the casing 110. The wave spring washer 260 positions the permanent magnet 200. However, the wave spring washer 260 can be omitted.

The casing 110 is a case or housing. The casing 110 includes a cylindrical portion 110a at the center in the direction of the center axis 230, and plate-like portions 110b at both ends. The cylindrical portion 110a is made of a highly thermally conductive material such as aluminum. The plate-like portions 110b are substantially square and have screw holes 110c in the four corners in order to fix the coreless motor 10 to another device. The coil back yoke 115 is provided on an inner peripheral side of the cylindrical portion 110a of the casing 110. A length in the direction of the center axis 230 of the coil back yoke 115 is substantially the same as a length in the direction of the center axis 230 of the permanent magnet 200. The cylindrical portion 110a at the center is made of a highly thermally conductive material such as aluminum in order to radiate heat generated in the coil back yoke 115, easily to outside. A cause of the heat generated in the coil back yoke 115 may be a loss (hereinafter referred to as “eddy current loss”) due to an eddy current generated by rotation of the permanent magnet 200 in the rotor 20. As a radial line is drawn in the radial direction from the center axis 230 toward the coil back yoke 115, the radial line penetrates the permanent magnet 200. That is, as viewed from the center axis 230, the coil back yoke 115 and the permanent magnet 200 appear to be overlapping each other.

On an inner peripheral side of the coil back yoke 115, the two-phase electromagnetic coils 100A, 100B are arrayed along the inner periphery of the coil back yoke 115. In the case where the electromagnetic coils 100A, 100B are not discriminated from each other, the electromagnetic coils 100A, 100B may be collectively called the “electromagnetic coil 100”. The electromagnetic coils 100A, 100B have an effective coil area and a coil end area. Here, the effective coil area is an area where a Lorentz force in a direction of rotation is applied to the rotor 20 when a current flows through the electromagnetic coils 100A, 100B. The coil end area is an area where a Lorentz force in a different direction from the direction of rotation (mainly in a direction orthogonal to the direction of rotation) is applied to the rotor 20. However, there are two coil end areas on both sides of the effective coil area. The Lorentz forces generated in these coil end areas are of the same magnitude but in opposite directions to each other and therefore offset each other. In the effective coil area, the conductor wires constituting the electromagnetic coils 100A, 100B are in a direction substantially parallel to the center axis 230. In the coil end areas, the conductor wires constituting the electromagnetic coils 100A, 100B are parallel to the direction of rotation of the rotor 20. When a radial line is drawn in the radial direction from the center axis 230 toward the coil back yoke 115, the radial line penetrates the effective coil area but does not penetrate the coil end areas. That is, as viewed from the center axis 230, the effective coil area appears to be overlapping both the permanent magnet 200 and the coil back yoke 115, whereas the coil end areas do not appear to be overlapping either of the permanent magnet 200 and the coil back yoke 115.

In the stator 15, the magnetic sensor 300 as a position sensor for detecting the phase of the rotor 20 is arranged, one each for each phase of the electromagnetic coils 100A, 100B. As described above, the magnetic sensor 300 is arranged on the side of the magnet side yoke 215 but not on the side of the magnet side yoke 216. In FIG. 1A, only the magnetic sensor 300 for one phase is shown. The magnetic sensor 300 is fixed onto a circuit board 310. The circuit board 310 is fixed to the casing 110. Here, the magnetic sensor 300 may be arranged on a perpendicular drawn from the coil end area to the center axis 230. Generally, the magnetic sensor 300 has anisotropy in sensitivity in the direction of magnetic flux density. With the magnetic sensor 300 arranged on the perpendicular drawn from the coil end area to the center axis 230, even when the intensity of a magnetic flux radiated from the electromagnetic coil 100 changes because of an increase or decrease of the current flowing through the electromagnetic coil 100, the anisotropy in sensitivity of the magnetic sensor 300 makes an output signal from the magnetic sensor 300 less likely to be influenced by the change in the magnetic flux due to the increase or decrease of the current.

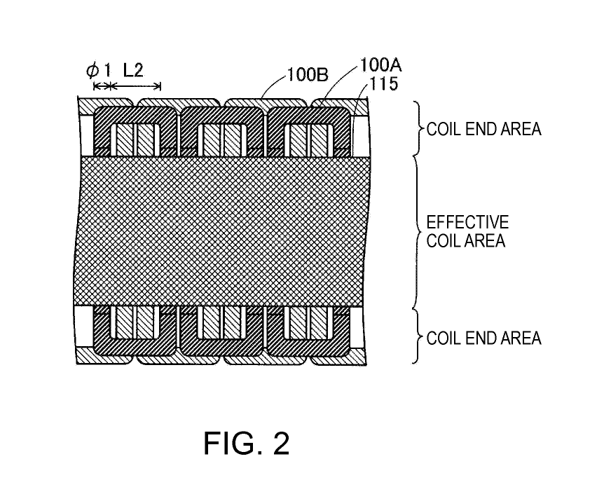

FIG. 2 is an explanatory view showing the coil back yoke 115 and the electromagnetic coils 100A, 100B expanded along the cylindrical surface, as viewed from the side of the coil back yoke 115. Each of the electromagnetic coils 100A, 100B is wound in the shape of a rounded rectangle. The electromagnetic coils of the same phase, for example, electromagnetic coils 100A and 100A or electromagnetic coils 100B and 100B, are not overlapping each other. However, the electromagnetic coils of different phases, for example, electromagnetic coils 100A and 100B, are partly overlapping each other. Also, bundles of conductors in the effective coil area of two electromagnetic coils 100B fit between two bundles of conductors in the effective coil area of an electromagnetic coil 100A.

Similarly, bundles of conductors in the effective coil areas of two electromagnetic coils 100A fit between two bundles of conductors in the effective coil area of an electromagnetic coil 100B. The coil end areas of the electromagnetic coil 100A are bent outward (forward in FIG. 2) from the cylindrical surface (see FIG. 1A) and do not overlap the coil end areas of the electromagnetic coil 100B. As the coil end areas of the electromagnetic coil 100A are bent outward in this manner, the electromagnetic coils 100A and 100B can be arranged on the same cylindrical surface without interfering with each other.

In this embodiment, a thickness φ1 of the bundle of conductors of the electromagnetic coils 100A, 100B and a space L2 between coil bundles in the effective coil area have the relation of L2≈2×φ1. That is, since the cylindrical surface where the electromagnetic coils 100A, 100B are arranged is mostly occupied by the bundles of conductors of the electromagnetic coils 100A, 100B, the area occupancy rate of the electromagnetic coils can be improved and the efficiency of the coreless motor 10 (FIGS. 1A and 1B) can be improved. In FIG. 2, for convenience of illustration, a gap is shown between neighboring electromagnetic coils. However, this can be almost zero as long as the relation L2≈2×φ1 holds.

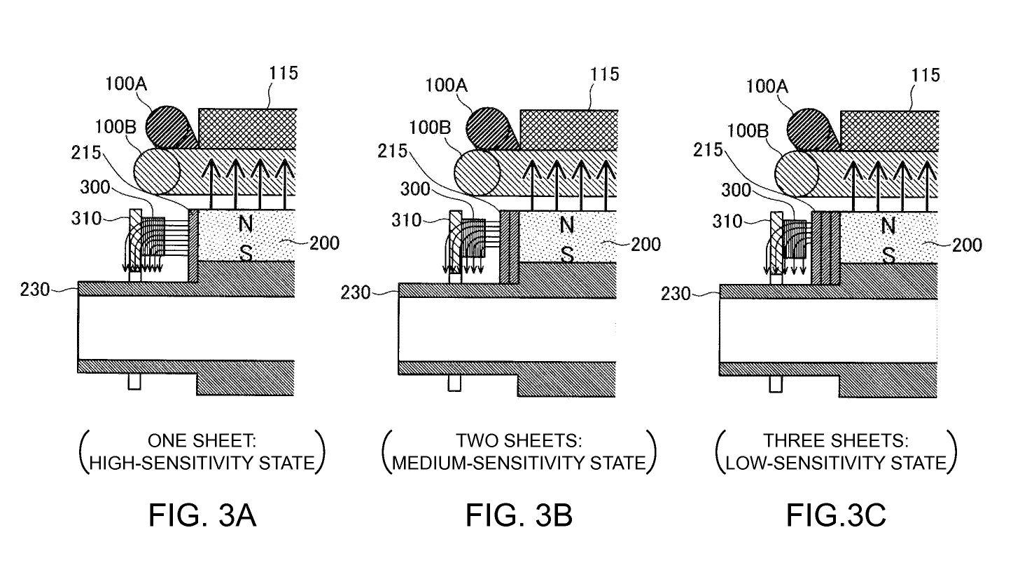

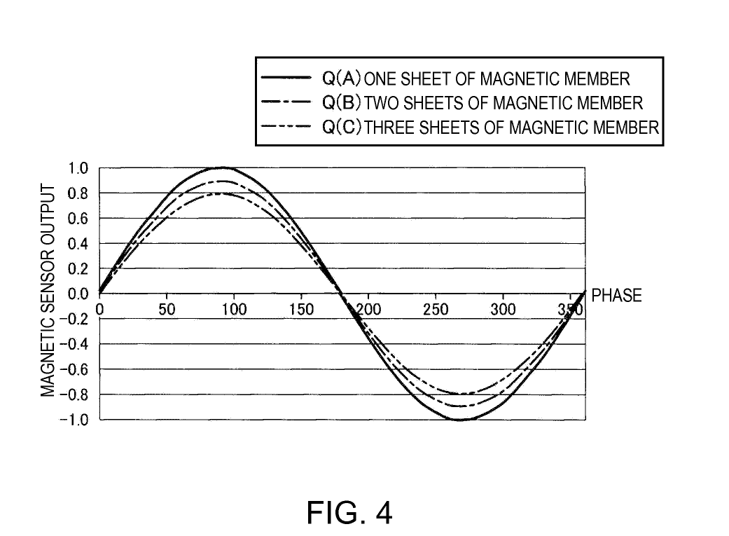

FIGS. 3A to 3C are explanatory views showing the vicinity of the magnet side yoke 215 on the magnetic sensor side, in an enlarged manner. FIG. 4 is an explanatory view showing an example of an output signal from the magnetic sensor 300. In this embodiment, as a material constituting the magnet side yokes 215, 216, a JNEX-Core silicon steel sheet with a thickness of 0.1 mm made by JFE Steel Corporation is used. JNEX-Core contains 6.5% of silicon (Si) in the entire area of the steel sheet. In FIGS. 3A to 3C, the number of silicon steel sheets used as the magnet side yoke 215 varies. For example, in the example shown in FIG. 3A, the number of silicon steel sheets used is one. In the example shown in FIG. 3B, two silicon steel sheets are used. In the example shown in FIG. 3C, three silicon steel sheets are used. Sensor outputs Q(A) to Q(C) shown in FIG. 4 correspond to FIGS. 3A to 3C, respectively. As described above, the magnet side yoke 215 reduces a magnetic flux leaking in a direction along the center axis 230 from the permanent magnet 200. However, a certain amount of magnetic flux leaks from the magnet side yoke 215. Here, the magnetic sensor 300 is arranged at a position that is further away from the magnet side yoke 215 in the direction along the center axis 230, as viewed from the permanent magnet 200. That is, the magnetic sensor 300 detects the density of the magnetic flux leaking from the magnet side yoke 215. As shown in the order from the sensor output Q(A) to Q(B) and Q(C) in FIG. 4, as the number of silicon steel sheets forming the magnet side yoke 215 increases, the waveform of the output signal from the magnetic sensor 300 gradually decreases in peak height. That is, as a larger number of silicon steel sheets are used to form the magnet side yoke 215 (the thickness of the magnet side yoke 215 is larger), the magnetic flux leaking from the magnet side yoke 215, of the magnetic fluxes from the permanent magnet 200, decreases. Consequently, the magnetic flux density detected by the magnetic sensor 300 decreases and the intensity of the output signal decreases. If the intensity of the output signal becomes too low, it is difficult to control the coreless motor 10 using the output signal. Therefore, the thickness of the magnet side yoke 215 may be preferably set to equal to or smaller than a thickness that allows the magnetic sensor 300 to output a predetermined output signal or greater. Meanwhile, as the thickness of the magnet side yokes 215 is reduced, the intensity of the output signal from the magnetic sensor 300 increases. Here, if the thickness of the magnet side yoke 215 is reduced further (for example, the magnet side yoke 215 is formed by a single 0.05-mm thick silicon steel sheet), the waveform of the output signal from the magnetic sensor 300 becomes saturated. Therefore, the thickness of the magnet side yoke 215 may be preferably set to equal to or greater than a thickness that does not cause the saturation of the waveform of the output signal from the magnetic sensor 300.

The magnetic flux leaking from the magnet side yoke 215 not only penetrates the magnetic sensor 300 but also reaches the bearing 240 and the casing 110. The leaking magnetic flux then causes an eddy current loss in the bearing 240 and the casing 110. Therefore, it is preferable to select a highest possible sensitivity type as the magnetic sensor 300 and increase the thickness of the magnet side yoke 215 thus reducing the magnetic flux that reaches the bearing 240 and the casing 110. Also, an insulating film may be provided on both sides of each of the silicon steel sheets (magnetic sheets) constituting the magnet side yoke 215. In this way, the eddy current loss in the magnet side yoke 215 due to the magnetic fluxes generated in the electromagnetic coils 100A, 100B can be reduced further. However, magnet side yoke 215 may be configured without the insulating film.

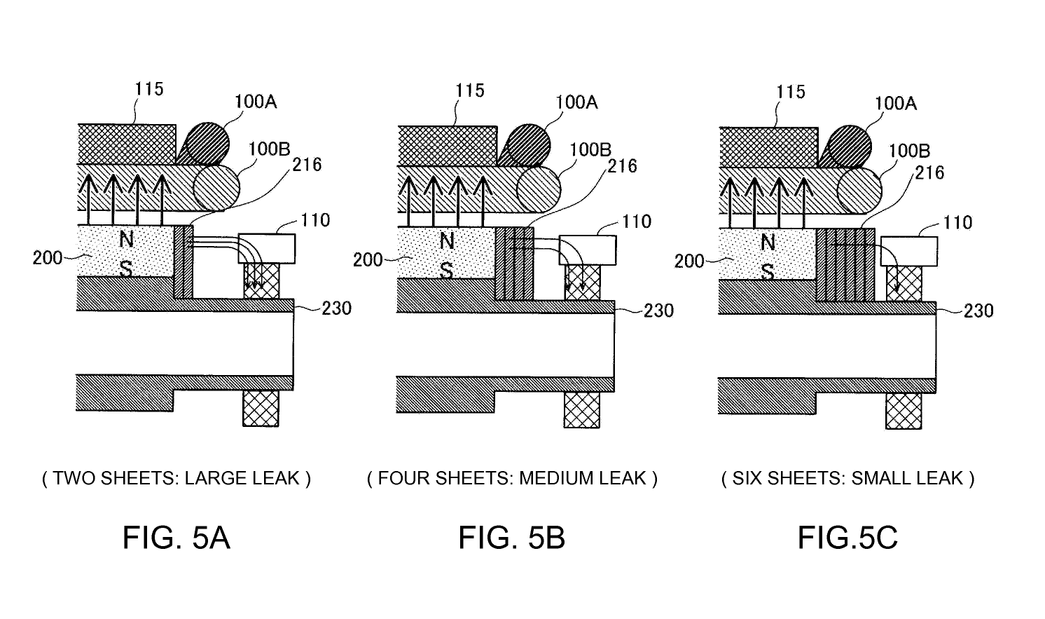

FIGS. 5A to 5C are explanatory views showing the vicinity of the magnet side yoke 216 opposite to the magnetic sensor side, in an enlarged manner . In FIGS. 5A to 5C, the number of silicon steel sheets used as the magnet side yoke 216 varies. For example, in the example shown in FIG. 5A, the number of silicon steel sheets is two (total thickness 0.2 mm). In the example shown in FIG. 5B, four silicon steel sheets are used (total thickness 0.4 mm). In the example shown in FIG. 5C, six silicon steel sheets are used (total thickness 0.6 mm). As described in the explanation of FIGS. 3A to 3C, as a larger number of silicon steel sheets are used to form the magnet side yoke 216 (the thickness of the magnet side yoke 216 is larger), the magnetic flux leaking from the magnet side yoke 216, of the magnetic fluxes from the permanent magnet 200, decreases. The magnetic flux leaking from the magnet side yoke 216 reaches the bearing 240 and the casing 110 and causes an eddy current loss in the bearing 240 and the casing 110. The eddy current loss is a principal element of iron loss along with hysteresis loss. In this embodiment, as the magnetic flux leaking from the magnet side yoke 216 becomes smaller, the consequence is better. It is preferable that the magnet side yoke 216 is thicker.

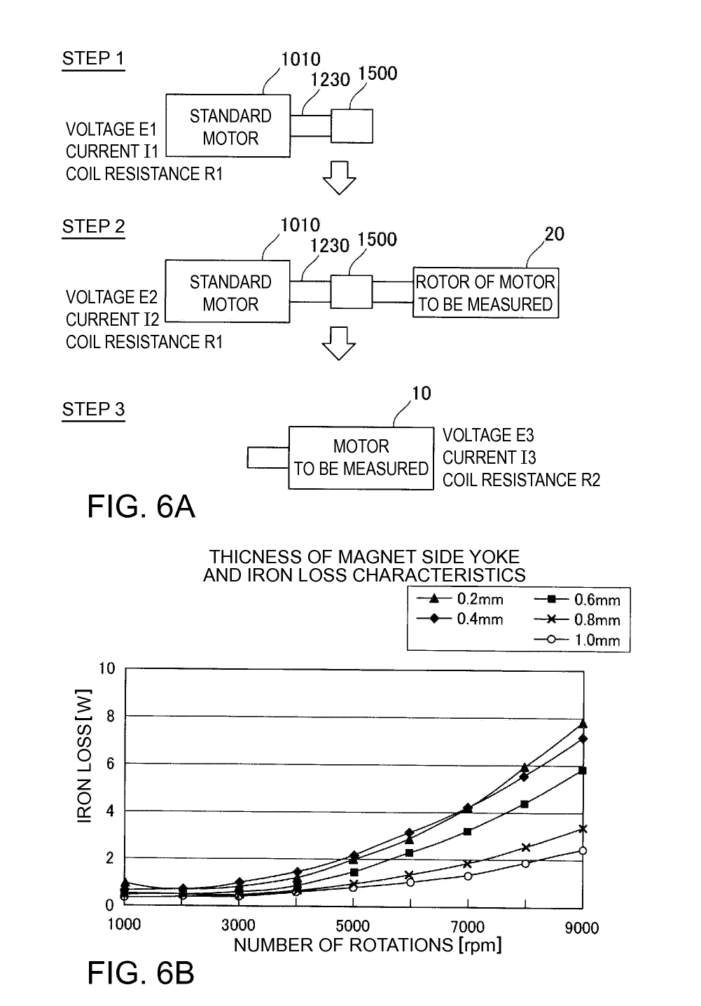

FIG. 6A is an explanatory view showing an example of an iron loss measuring method. In Step 1, first, loss characteristics of a standard motor 1010 are measured. A coupling 1500 for connecting the motor to be measured 10 is attached to a center axis 1230 of the standard motor 1010. In this state, the standard motor 1010 is rotated at a predetermined number of rotations N, and a voltage E1 and a current I1 applied to the standard motor 1010 are measured. The rotation state at this point is a so-called no-load rotation state. A first total loss P1all of the standard motor 1010 at this point is E1×I1. The first total loss P1all is the sum of a mechanical loss P1m, a copper loss P1cu and an iron loss P1fe. Here, if the electrical resistance of the electromagnetic coils of the standard motor 1010 is R1, the copper loss P1cu is expressed by I1²×R1.

In Step 2, only the rotor 15 of the motor to be measured 10 is connected to the standard motor 1010. The standard motor 1010 is rotated at the same number of rotations N as in Step 1, and a voltage E2 and a current 12 applied to the standard motor 1010 are measured. A second total loss P2all at this point is E2×I2. The second total loss P2all is the first total loss P1all plus a mechanical loss P2m of the motor to be measured 10. That is, the difference between the second total losses P2all and the first total loss P1all (P2all−P1all) is the mechanical loss P2m of the motor to be measured 10.

In Step 3, only the motor to be measured 10 is rotated at the same number of rotations N as in Steps 1 and 2, and a voltage E3 and a current 13 applied to the motor to be measured 10 are measured. A total loss P3all of the motor to be measured 10 at this point is E3×I3. The total loss P3all is the sum of a mechanical loss P3m, a copper loss P3cu and an iron loss P3fe.

Here, the mechanical loss P3m has the same value as the mechanical loss P2m measured in Step 2. Also, if the electrical resistance of the electromagnetic coils of the motor to be measured 10 is R2, the copper loss P3cu can be expressed by I3²×R2. Therefore, the iron loss of the motor to be measured can be calculated by (E3×I3−P3m−I3²×R2).

FIG. 6B is an explanatory view showing the relation between the thickness of the magnet side yoke 216 and the iron loss of the motor to be measured. In this iron loss, a magnetic flux is generated as an eddy current loss between the bearing 240 and the casing 110 by the number of rotations (electrical angle ω) of the permanent magnet 200 in the rotor 20 of the motor to be measured 10. FIG. 6B shows iron loss characteristics of the motor where the thickness of the magnet side yoke 216 is varied to 0.2 mm, 0.4 mm, 0.6 mm, 0.8 mm and 1.0 mm by changing the number of silicon steel sheets forming the magnet side yoke 216. Here, the thickness of one silicon steel sheet is 0.1 mm. As is clear from the graph, as the number of silicon steel sheets is increased, the iron loss of the motor to be measured is reduced. The amount of decrease of iron loss when the number of silicon steel sheets is increased from six to eight is larger than the amount of decrease of iron loss when the number of silicon steel sheets is increased from two to four. However, the iron loss is not significantly reduced even when the number of silicon steel sheets is increased from eight to ten. As the reason for this, the following can be considered. The iron loss includes the eddy current loss and the hysteresis loss. The eddy current loss of the iron loss can be reduced by increasing the thickness of the magnet side yoke 216. However, the hysteresis loss is difficult to reduce even if the thickness of the magnet side yoke 216 is increased. Therefore, it can be considered that this hysteresis loss is left. Based on the above results, the eddy current loss of the iron loss can be reduced sufficiently by providing the magnet side yoke 216 with a thickness of approximately 1 mm.

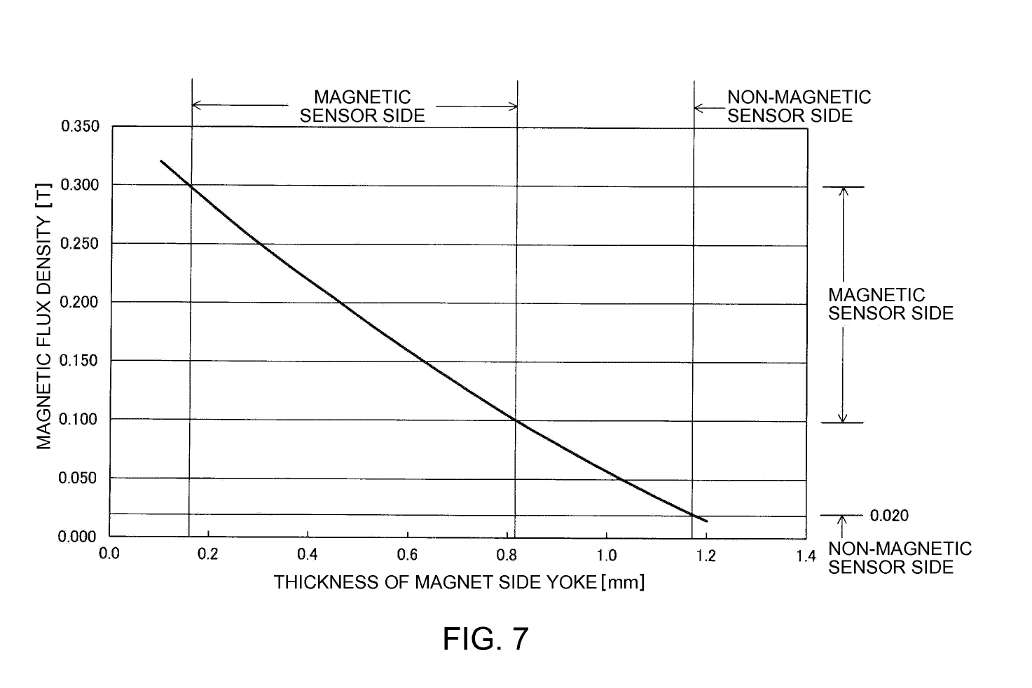

FIG. 7 is an explanatory view showing the relation between the thickness of the magnet side yoke and the magnetic flux density on the surface of the magnet side yoke. Here, the “magnetic flux density on the surface of the magnet side yoke” means the magnetic flux density on the surface opposite to the permanent magnet, of the magnet side yoke. By reducing the magnetic flux density on the surface of the magnet side yoke to 0.02 tesla (20 millitesla) or less, the magnetic flux reaching the bearing 240 and the casing 110 can be reduced and the generation of the eddy current loss in the bearing 240 and the casing 110 can be restrained. Thus, the iron loss can be reduced. The thickness of the magnet side yoke 216 where the magnetic flux density on the surface of the magnet side yoke is 0.02 tesla is 1.2 mm. Based on the thickness of the magnet side yoke 216 and the tendency of eddy current loss shown in FIG. 6B, it can be considered that little eddy current loss occurs if the thickness of the magnet side yoke 216 is 1.2 mm. Therefore, by reducing the magnetic flux density on the surface of the magnet side yoke 216 on the side where the magnetic sensor is not provided to less than 0.02 tesla (20 millitesla), the magnetic flux reaching the bearing 240 and the casing 110 can be reduced and the generation of the eddy current loss in the bearing 240 and the casing 110 can be restrained. Thus, the iron loss can be reduced.

As for the magnet side yoke 215 on the side where the magnetic sensor 300 is provided, since the results in FIGS. 3A to 3C and FIG. 4 show that the output waveform from the magnetic sensor is almost saturated when the number of silicon steel sheets is one (0.1 mm), it is preferable that the thickness of the magnet side yoke 215 has a value greater than 0.1 mm. The magnetic flux density on the surface of the magnet side yoke 215 in this case is 0.3 tesla (300 millitesla) or greater. If the magnet side yoke 215 is increased in order to reduce the generation of the eddy current loss in the bearing 240 and the casing 110, the magnetic flux density at the magnetic sensor 300 is reduced excessively and the detection accuracy of the magnetic sensor 300 is impaired. If the magnetic flux density on the surface of the magnet side yoke 215 falls below 0.1 tesla (100 millitesla), the detection accuracy of the magnetic sensor 300 is impaired. Therefore, it is preferable that the thickness of the magnet side yoke 215 is 0.8 mm or less. Also, it is preferable that a Hall IC which includes an amplifier circuit for a signal from a Hall element and a temperature compensation circuit is used for the magnetic sensor 300. It is preferable to use a high-sensitivity sensor with a high amplification gain via the amplifier circuit, and thereby minimize the eddy current loss received from the magnet side yoke 215.

Generally, a motor uses a permanent magnet that is magnetized with various intensities. Therefore, a preferable thickness of a magnet side yoke varies depending on the intensity of the permanent magnet. In such cases, it is similarly preferable that the magnetic flux density on the surface of the first magnet side yoke 215 is equal to or greater than 100 millitesla but smaller than or equal to 300 millitesla and that the magnetic flux density on the surface of the second magnet side yoke 216 is less than 20 millitesla.

As described above, according to the embodiment, the magnetic flux density on the surface of the second magnet side yoke 216 on the side where the magnetic sensor 300 is not arranged is set to be smaller than the magnetic flux density on the surface of the first magnet side yoke 215 on the side where the magnetic sensor 300 is arranged. Therefore, the leakage of the magnetic flux from the second magnet side yoke 216 can be reduced. Consequently, the iron loss due to the eddy current loss in the casing 110 and the bearing 240 on the side where the magnetic sensor 300 is not arranged can be reduced and the efficiency of the coreless motor 10 can be improved.

To realize the above configuration, it is preferable that the thickness of the second magnet side yoke 216 in the direction along the center axis 230 is thicker than the thickness of the first magnet side yoke 215 in the direction along the center axis 230. Alternatively, the second magnet side yoke 216 may be made of a material with a higher relative permeability than the first magnet side yoke 215. The material with a higher relative permeability is less likely to leak magnetic fluxes to outside. Therefore, using the material with a higher relative permeability for the magnet side yoke 216 has a similar effect to increasing the thickness of the magnet side yoke 216. Also, as the magnetic flux density on the surface of the first magnet side yoke 215 is equal to or greater than 100 millitesla but smaller than or equal to 300 millitesla and that the magnetic flux density on the surface of the second magnet side yoke 216 is less than 20 millitesla, the eddy current loss and iron loss in the casing 110 and the bearing 240 on the side of the second magnet side yoke 216 can be significantly reduced. Moreover, since the thickness of the first magnet side yoke 215 is not excessively thick, the magnetic sensor 300 can detect the magnetic flux passed through the first side yoke and the output signal from the magnetic sensor 300 can be used to control the coreless motor 10.

This embodiment is described using the coreless motor 10. However, the motor used is not limited to a coreless motor and may be a motor with a core.

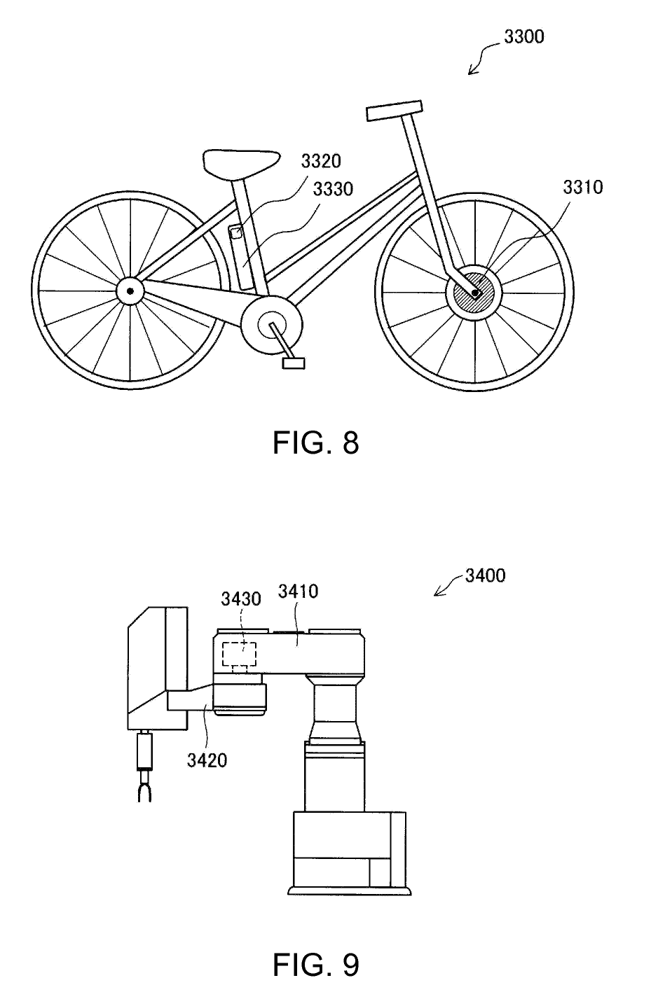

FIG. 8 is an explanatory view showing an electric-powered bicycle (power-assisted bicycle) as an example of a mobile unit utilizing a motor/power generator according to a modification of the embodiment of the invention. This bicycle 3300 has a motor 3310 on a front wheel, and has a control circuit 3320 and a rechargeable battery 3330 on a frame below a saddle. The motor 3310 uses electric power from the rechargeable battery 3330 to drive the front wheel and thus assists in traveling. At the time of braking, the rechargeable battery 3330 is charged with electric power regenerated by the motor 3310. The control circuit 3320 is a circuit which controls the driving of the motor and the regeneration. As this motor 3310, the foregoing various coreless motors 10 can be used.

FIG. 9 is an explanatory view showing an example of a robot utilizing a motor according to a modification of the embodiment of the invention. This robot 3400 has first and second arms 3410, 3420 and a motor 3430. The motor 3430 is used for horizontally rotating the second arm 3420 as a driven member. As this motor 3430, the foregoing various coreless motors 10 can be used.

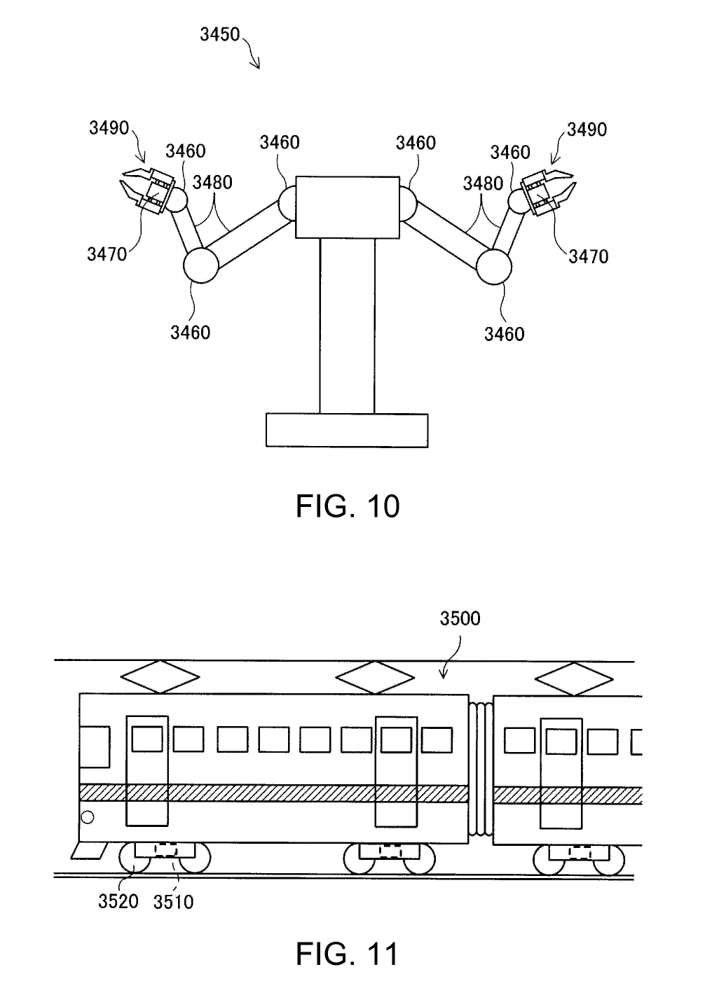

FIG. 10 is an explanatory view showing an example of a two-arm seven-axis robot utilizing a motor according to a modification of the embodiment of the invention. A two-arm seven-axis robot 3450 has a joint motor 3460, a grasping unit motor 3470, an arm 3480, and a grasping unit 3490. The joint motor 3460 is arranged at positions equivalent to shoulder joints, elbow joints and wrist joints. In order to operate the arm 3480 and the grasping unit 3490 three-dimensionally, two joint motors 3460 per joint are provided. The grasping unit motor 3470 causes the grasping unit 3490 to open and close and thus causes the grasping unit 3490 to grasp an object. In the two-arm seven-axis robot 3450, the foregoing various coreless motors can be used as the joint motor 3460 or the grasping unit motor 3470.

FIG. 11 is an explanatory view showing a railway vehicle utilizing a motor according to a modification of the embodiment of the invention. This railway vehicle 3500 has an electric-powered motor 3510 and a wheel 3520. The electric-powered motor 3510 drives the wheel 3520. Moreover, at the time of braking the railway vehicle 3500, the electric-powered motor 3510 is used as a power generator and electric power is regenerated. As this electric-powered motor 3510, the foregoing various coreless motors 10 can be used.

An embodiment of the invention is described above, based on several examples. However, the embodiment of the invention is for facilitating the understanding of the invention and should not be considered to limit the invention. Various changes and modifications can be made to the invention without departing from the scope and the appended claims of the invention. As a matter of course, the invention includes equivalents thereof.

The present application claims priority based on Japanese Patent Application No. 2011-149644 filed on Jul. 6, 2011, the disclosure of which is hereby incorporated by reference in its entirety.

What is claimed is:

1. An electromechanical device comprising:
a rotor including a center axis, a permanent magnet arranged on a first cylindrical surface along an outer periphery of the center axis, and first and second magnet side yokes arranged at both end parts in a direction of the center axis, of the permanent magnet; and
a stator including an electromagnetic coil arranged on a second cylindrical surface along an outer periphery of the permanent magnet, and a magnetic sensor arranged opposite the permanent magnet with the first magnet side yoke located between the magnetic sensor and the permanent magnet;
wherein the first and second magnet side yokes are configured in such a way that a magnetic flux density on a surface opposite to the permanent magnet, of the second magnet side yoke on the side where the magnetic sensor is not arranged, is smaller than a magnetic flux density on a surface opposite to the permanent magnet, of the first magnet side yoke.

2. The electromechanical device according to claim 1, wherein the first and second magnet side yokes are configured in such a way that a thickness in a direction along the center axis of the second magnet side yoke is thicker than a thickness in a direction along the center axis of the first magnet side yoke.

3. The electromechanical device according to claim 1, wherein the second magnet side yoke is made of a material with a higher relative permeability than the first magnet side yoke.

4. The electromechanical device according to claim 1, wherein the magnetic flux density on the surface opposite to the permanent magnet, of the first magnet side yoke, is equal to or greater than 100 millitesla but smaller than or equal to 300 millitesla, and the magnetic flux density on the surface opposite to the permanent magnet, of the second magnet side yoke, is less than 20 millitesla.

5. A robot comprising the electromechanical device according to claim 1.

6. A robot comprising the electromechanical device according to claim 2.

7. A robot comprising the electromechanical device according to claim 3.

8. A robot comprising the electromechanical device according to claim 4.

9. A mobile unit comprising the electromechanical device according to claim 1.

10. A mobile unit comprising the electromechanical device according to claim 2.

11. A mobile unit comprising the electromechanical device according to claim 3.

12. A mobile unit comprising the electromechanical device according to claim 4.
